(19) United States
(12) Patent Application Publication
(10) Pub. No.: US 2005/0141439 A1
(43) Pub. Date: Jun. 30, 2005

(54) Method for enabling the user of a local computer operating in an instant messenger environment to make a voice communications link

(76) Inventors: Wei-Lien Hsu, Austin, TX (US); Pao-Chu Huang Chiao, Taipei City (TW)

Correspondence Address: Allston L. Jones;PETERS, VERNY, JONES & SCHMITT LLP, Suite 230, 425 Sherman Avenue, Palo Alto, CA, 94306-1840, US

(21) Appl. No.: 11/013,005

(22) Filed: Dec. 15, 2004

(30) Foreign Application Priority Data
Dec. 26, 2003 (TW) 092137066
Oct. 14, 2004 (TW) 093131175

(51) Int. Cl. H04Q 11/00

(52) U.S. Cl. 370/259

(57) ABSTRACT

A method for making a voice communications link is implemented using local and remote computers, each of which operates in an instant messenger environment and is connected to a data network. The local computer is equipped with a call forwarding device for connecting to a telephone network. The method includes: a) in response to an incoming phone call placed by a calling party and received by the local computer through the call forwarding device, enabling activation of the instant messenger function of the local computer for paging the remote computer; and b) in response to an acknowledge message issued by the remote computer to accept establishment of the voice communications link and received by the local computer through the data network, activating the instant messenger function of the local and remote computers for establishing the voice communications link.

### CROSS-REFERENCE TO RELATED APPLICATION

This application claims priority of Taiwanese application no. 092137066, filed on Dec. 26, 2003, and Taiwanese application no. 093131175, filed on Oct. 14, 2004.

### BACKGROUND OF THE INVENTION

1. Field of the Invention

The invention relates to a method for making a voice communications link, more particularly to a method for enabling the user of a local computer operating in an instant messenger environment to make a bi-directional real-time voice communications link.

2. Description of the Related Art

Instant messenger applications, such as MSN, ICQ, Yahoo! Messenger, AOL messenger, etc., are convenient communications channels well known to most Internet users. In use, a computer user first installs an instant messenger application on his/her computer, and then establishes a buddy list so that data, such as nicknames, pictures, etc., of buddies (i.e., other computer users of interest), as well as individual on-line status of the buddies, are shown together with the buddy list during subsequent activation of the instant messenger application.

To communicate with a buddy, the computer user first checks for the current status (e.g., on-line, off-line or unavailable) of the intended buddy. The computer user and the intended buddy are able to exchange messages directly when the intended buddy is on-line.

The format of exchanged messages is not limited to a text format. In particular, present technology makes it also possible to exchange messages in voice and/or video format in real-time.

As shown in FIG. 1, taking the MSN instant messenger application as an example, aside from enabling communications through text messages, other options are available in the buddy list 9 to permit bi-directional information exchange through activation of voice chat 91, video exchange via activation of web camera 92, activation of net meeting 93, or a telephone link 94. The voice chat function requires installation of audio devices in the user's computer, whereas the video exchange and net meeting functions require installation of a web camera in the user's computer.

On the other hand, the telephone link option involves making a telephone connection through the Voice over Internet Protocol (VoIP). To be able to make use of this option, the computer user must register with a VoIP service provider beforehand and must also make pre-payment arrangements. The procedure as such is rather complicated and inconvenient for most computer users.

While voice communications through the VoIP protocol incurs less expense for long distance communications, in view of the troublesome procedure for registration and making pre-payment arrangements, user preference for voice communications through the VoIP protocol is rather low.

In addition, computer users are not always present in front of their computers. Current instant messenger applications do not provide a function of allowing computer users to receive messages when they are not in front of their computers.

### SUMMARY OF THE INVENTION

Therefore, the object of the present invention is to provide a method for making a voice communications link that can overcome at least one of the aforesaid drawbacks of the prior art.

According to one aspect of the present invention, there is provided a method for making a voice communications link to be implemented using local and remote computers, each of which operates in an instant messenger environment and is connected to a data network. The local computer is equipped with a call forwarding device for connecting to a telephone network. The method comprises:
a) in response to an incoming phone call placed by a calling party and received by the local computer through the call forwarding device that is connected to the telephone network, enabling activation of the instant messenger function of the local computer for paging the remote computer; and
b) in response to an acknowledge message issued by the remote computer to accept establishment of the voice communications link and received by the local computer through the data network, activating the instant messenger function of the local and remote computers for establishing the voice communications link that includes a telephone network link between the calling party and the local computer, and a data network link between the local and remote computers.

According to another aspect of the present invention, there is provided a method for making a voice communications link to be implemented using local and remote computers, each of which operates in an instant messenger environment, is connected to a data network, and is equipped with a respective call forwarding device for connecting to a telephone network. The method comprises:
a) in response to an incoming phone call placed by a calling party and received by the local computer through the call forwarding device that is connected to the telephone network, enabling activation of the instant messenger function of the local computer for paging the remote computer;
b) activating the instant messenger function of the remote computer for enabling the remote computer to issue an acknowledge message to the local computer when the remote computer is paged through the data network;
c) enabling the remote computer to activate the call forwarding device thereof for placing an outgoing phone call to an intended call recipient through the telephone network; and
d) activating the instant messenger function of the local and remote computers for establishing the voice communications link that includes a first telephone network link between the calling party and the local computer, a data network link between the local and remote computers, and a second telephone network link between the remote computer and the intended call recipient.

According to yet another aspect of the present invention, there is provided a method for making a voice communications link to be implemented using a local computer that operates in an instant messenger environment, that is connected to a data network, and that is equipped with a call forwarding device for connecting to a telephone network. The method comprises:
a) in response to paging of the local computer through the data network by a remote computer that also operates in the instant messenger environment, enabling activation of the call forwarding device for placing an outgoing phone call to an intended call recipient through the telephone network using a specified telephone number, thereby permitting establishment of the voice communications link between the user of the remote computer and the intended call recipient.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram illustrating different communication modes available in current MSN instant messenger applications;

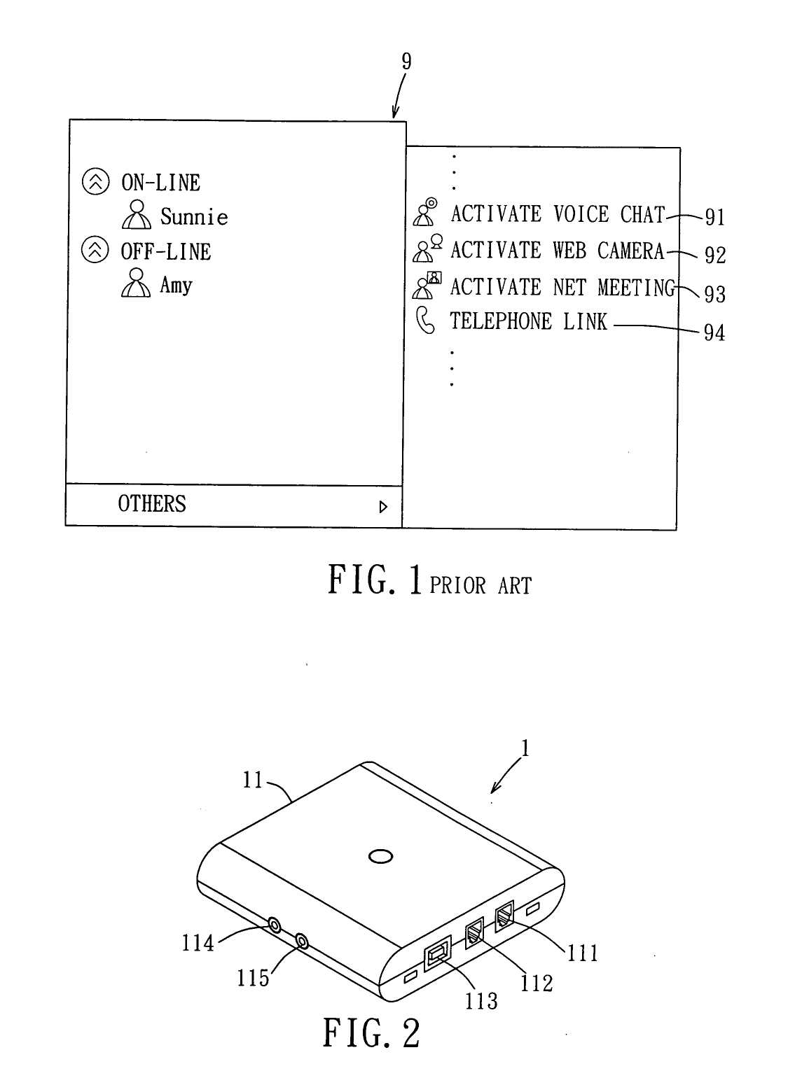

FIG. 2 is a perspective view of a call forwarding device used in the method for making a voice communications link according to the present invention;

FIG. 3 is a block diagram illustrating components of the call forwarding device of FIG. 2;

FIG. 4 illustrates a graphical user interface generated in the method for making a voice communications link according to the present invention;

FIG. 5 illustrates how buddy preferences are set in the method for making a voice communications link according to the present invention;

FIG. 6 illustrates how a call forwarding option is configured in the method for making a voice communications link according to the present invention;

FIG. 7 is a schematic diagram to illustrate a voice communications link made between a calling party and an intended call recipient in the method for making a voice communications link according to the present invention;

FIGS. 8 to 11 are flowcharts of the preferred embodiment for making the voice communications link of FIG. 7;

FIG. 12 is a schematic diagram to illustrate another voice communications link made between a calling party and an intended call recipient in the method for making a voice communications link according to the present invention; and

FIGS. 13 and 14 are flowcharts of the preferred embodiment for making the voice communications link of FIG. 12.

### DETAILED DESCRIPTION OF THE PREFERRED EMBODIMENT

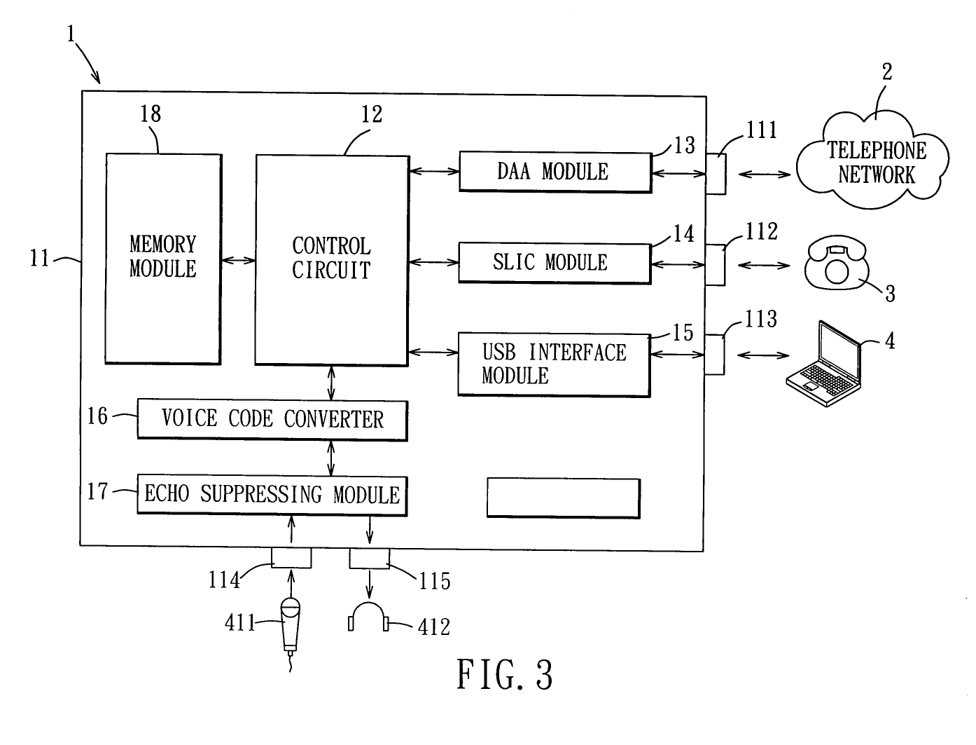

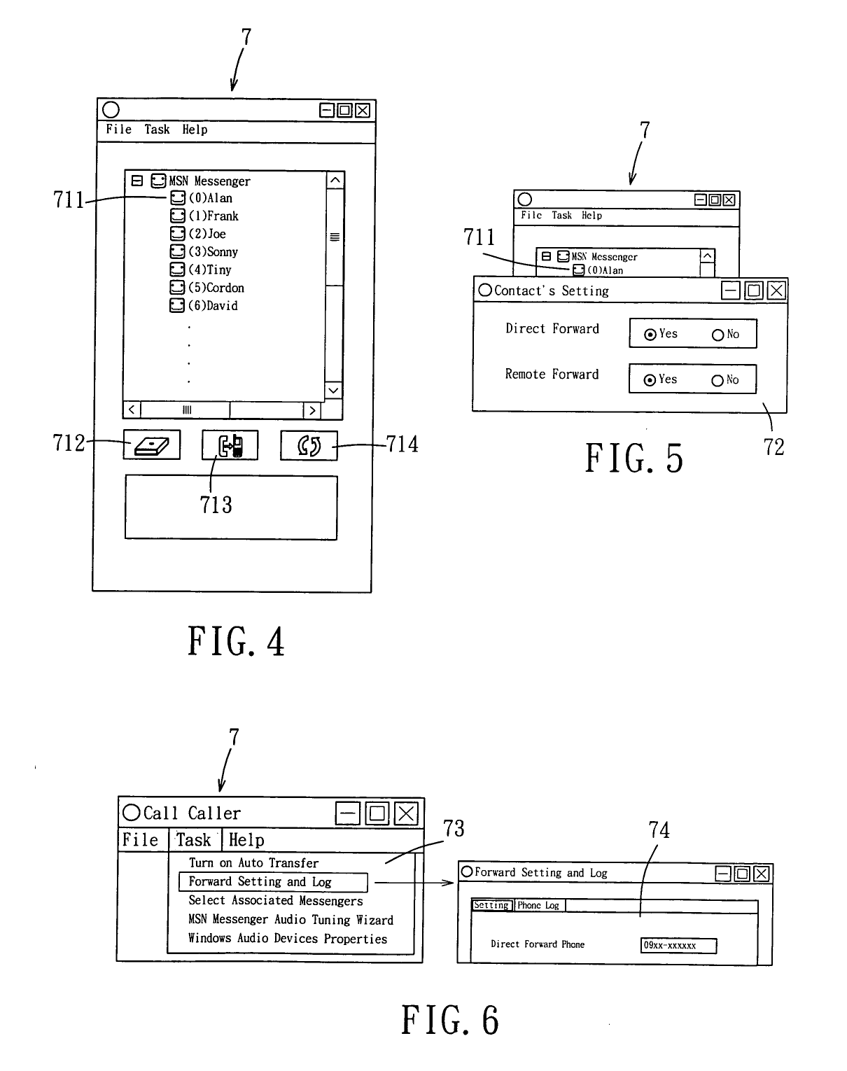

FIGS. 2 and 3 illustrate a call forwarding device 1 used in the method for making a voice communications link according to the present invention. The call forwarding device 1 includes a portable housing 11, and a PSTN port 111, a telephone port 112 and a USB port 113 provided on one side of the housing 11. The call forwarding device 1 further includes a microphone jack 114 and an earphone jack 115 provided on another side of the housing 11 for connecting with an external microphone 411 and an earphone device 412, respectively.

Inside the housing 11, there are disposed a control circuit 12, a data access arrangement (DAA) module 13, a subscriber line interface circuit (SLIC) module 14, a USB interface module 15, a voice code converter 16, an echo suppressing module 17, and a memory module 18. The DAA module 13 is connected electrically to the control circuit 12 and the PSTN port 111. The SLIC module 14 is connected electrically to the control circuit 12 and the telephone port 112. The USB interface module 15 is connected electrically to the control circuit 12 and the USB port 113. The voice code converter 16 is connected electrically to the control circuit 12 and is operable so as to process voice signals to and from the earphone jack 115 and the microphone jack 114. The echo suppressing module 17 is connected electrically to the voice code converter 16. The memory module 18 is connected electrically to the control circuit 12.

The DAA module 13 is connected to a telephone network 2, such as a public switched telephone network (PSTN), through the PSTN port 111. The SLIC module 14 is connected to a telephone set 3 through the telephone port 112. Preferably, in case of an incoming phone call through the telephone network 2, the incoming phone call can be accepted through the telephone set 3 in a manner well known to those skilled in the art. Moreover, when an incoming phone call arrives at a time the call forwarding device 1 is operated to place an outgoing phone call, a busy tone will be detected by the party who made the incoming phone call in a known manner.

The USB interface module 15 is connected to an electronic device 4 through the USB port 113. The electronic device 4 is operable in an instant messenger environment (i.e., it has an instant messenger application installed therein), and can be a personal computer, a notebook computer, etc. In practice, many alternative schemes, such as through an IEEE 1394 serial port, known to those skilled in the art are available for establishing electrical connection between the call forwarding device 1 and the electronic device 4.

Once a microphone 411 and an earphone device 412 are connected respectively to the microphone jack 114 and the earphone jack 115, an ordinary telephone conversation can proceed. In this manner, it is not necessary to install the aforesaid telephone set 3 when accepting an incoming phone call. Moreover, while the call forwarding device 1 is exemplified as being suitable for use with an external microphone 411, it is apparent to those skilled in the art that an internal microphone may be employed to accomplish the function of picking-up voice signals. In addition, the earphone device 412 may be an external speaker or any other conventional sound reproducing device.

In this embodiment, the combined functions of the control circuit 12 and the voice code converter 16 are realized using a Tiger Jet® TJ560 series control chipset. This particular control chipset, which is able to process the USB transmission data format, is ideal for processing USB transmission data received from the electronic device 4 through the USB interface module 15. On the other hand, the TJ560 series control chipset is further operable so as to perform sound effect format conversion from μ-law format to pulse-coded-modulation (PCM) format and vice-versa upon voice signals from and to the microphone 411 and the earphone device 412. The echo suppressing module 17 can be realized using OKI® MSM7602 or DSP D16559TDA control chipset, and can suppress echo noise in the voice data that is inputted into the voice code converter 16. It should be noted herein that the aforesaid control chipsets may be replaced with other control chipsets that can perform the same functions.

After receiving a call forwarding command through the USB interface module 15, the control circuit 12 is able to dial a specified telephone number through the DAA module 13. A calling party is able to talk to an intended call recipient through the external microphone 411, and to listen to the call recipient through the earphone device 412. Incoming and outgoing voice signals undergo code conversion through the voice code converter 16 for processing by the control circuit 12 and for reproduction by the earphone device 412. The call forwarding device 1 further provides a message recording function, in which voice data are recorded in the memory module 18 (in this embodiment, the memory module 18 has a 32-MB capacity), similar to that provided by a telephone answering machine.

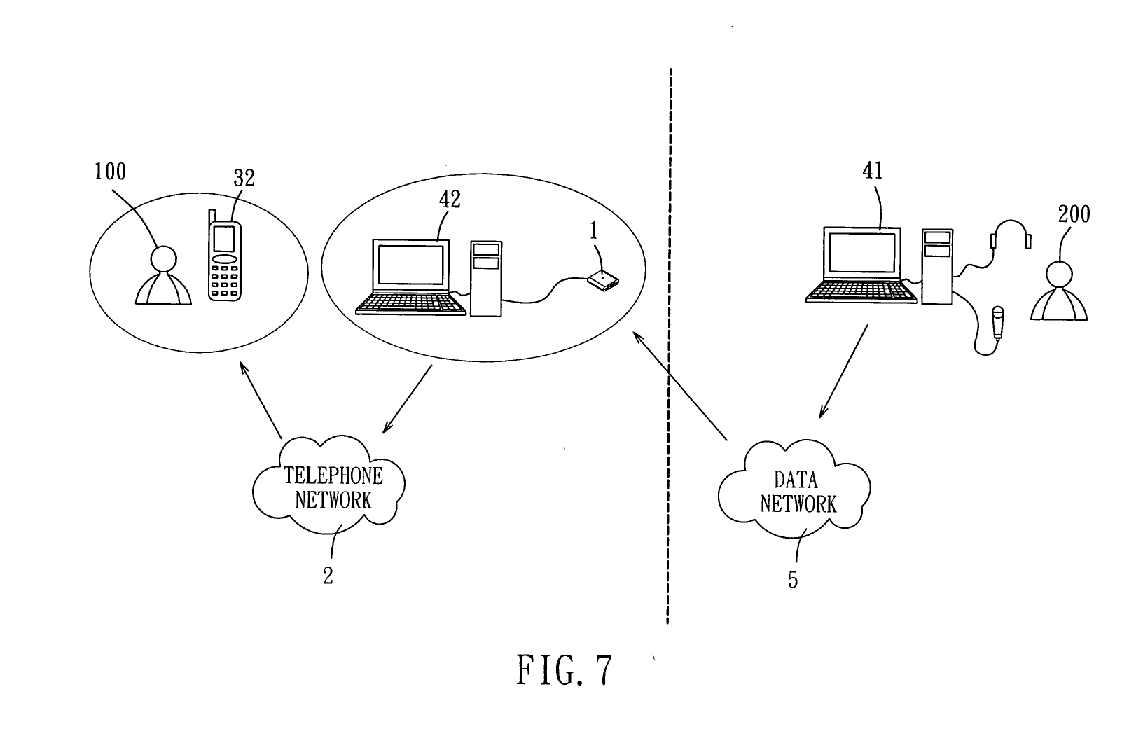

FIG. 4 illustrates a graphical user interface 7 generated upon execution by the electronic device 4 of a call forwarding application that is associated with the call forwarding device 1 in the method for making a voice communications link according to the present invention. The interface 7 includes a buddy list 711, an activation key 712, an automatic forwarding key 713, and a synchronization transmission key 714.

The activation key 712 is used to activate or deactivate the call forwarding device 1. The automatic forwarding key 713 is used to enable or disable automatic call forwarding options. The synchronization transmission key 714 is used to synchronize the contents of the buddy list 711 with that of the instant messenger application that is installed in the electronic device 4.

The method for making a voice communications link according to the present invention will now be described with reference to the following illustrative examples. In the examples, it is assumed that: (i) the user of a local computer is an intended call recipient; or (ii) the user of the local computer is a calling party.

(i) The User is an Intended Call Recipient:

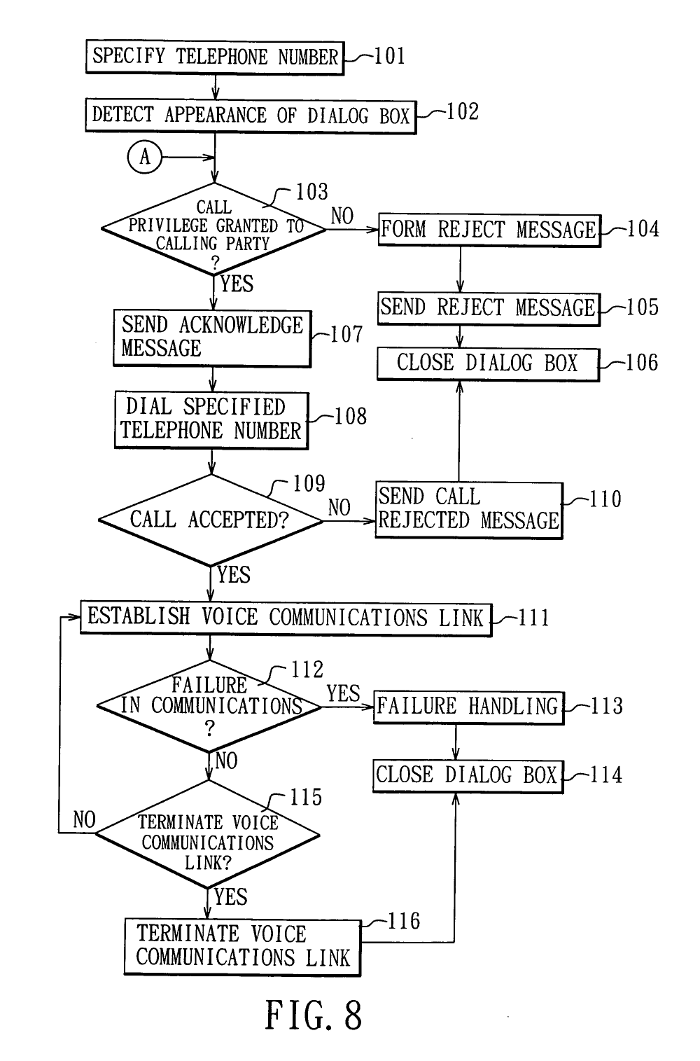

Referring to FIG. 5, the user of the local computer is able to set buddy preferences for each buddy in the buddy list 711. In this embodiment, the buddy preferences include: (A) “Direct Forward” call privilege; and (B) “Remote Forward” call privilege. For instance, if the user wishes to grant a buddy nicknamed ‘Alan’ the “Direct Forward” and “Remote Forward” call privileges, the user clicks on an icon associated with the nickname ‘Alan’ to result in a corresponding pop-up menu 72. The user then sets the relevant buddy preferences through the pop-up menu 72.

The “Direct Forward” and “Remote Forward” options will be described in greater detail in the succeeding paragraphs.

(A) “Direct Forward” option

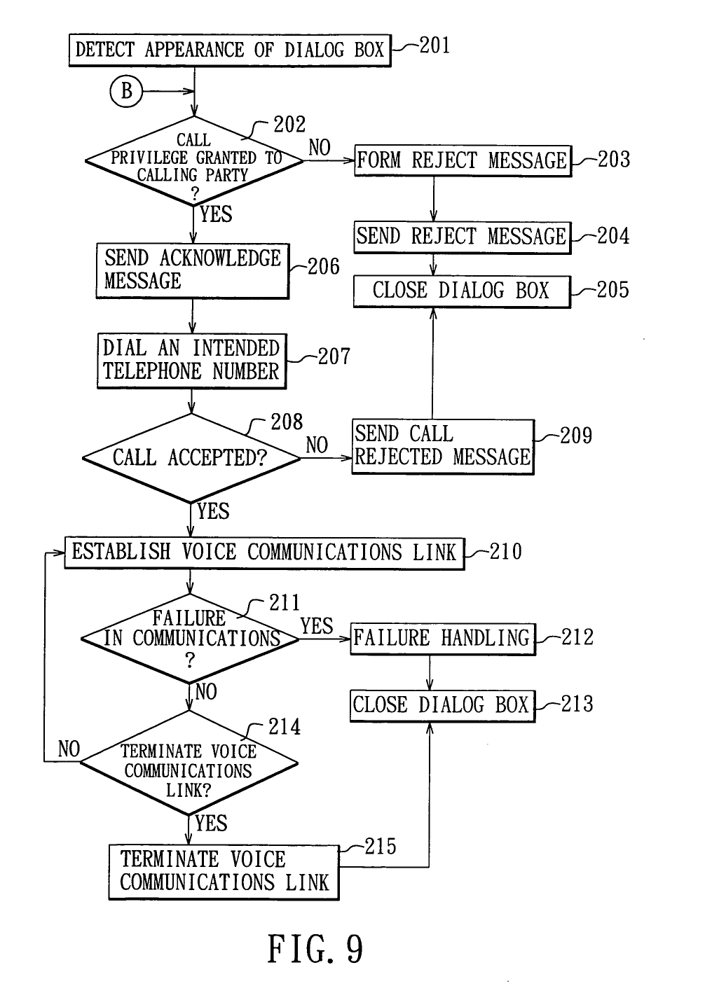

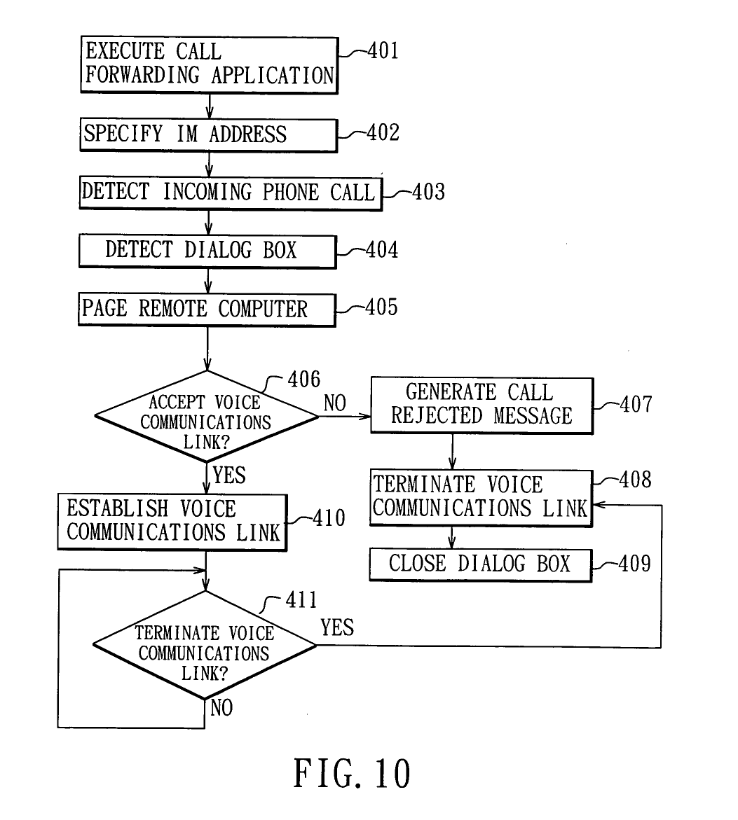

As shown in FIG. 6, in order to enable use of the “Direct Forward” option, the user of the local computer must first select a “Forward Setting and Log” item in a Task menu 73 of the interface 7. Upon selection of said item, a corresponding dialog box 74 pops-up to enable the user to input a specific telephone number, such as his mobile phone number 09xx-xxxxxx. Referring to FIG. 7, it is assumed that the user (hereinafter referred to as the intended call recipient 100), who is a resident of the United States, is not at home, is in another state, and is carrying a mobile phone 32 with him. A person (hereinafter referred to as the calling party 200) living in Taiwan wishes to contact the intended call recipient 100. Through the use of a remote computer 41 that operates in an instant messenger environment, the calling party 200 is able to page the local computer 42 (that also operates in a similar instant messenger environment) of the intended call recipient 100 via a data network 5. Since the local computer 42 is connected to the call forwarding device 1, and since the call forwarding device 1 is connected to a telephone network 2, the “Direct Forward” option enables the calling party 200 to get in touch with the intended call recipient 100 through a voice communications link that includes a data network link between the remote and local computers 41, 42, and a telephone network link between the call forwarding device 1 of the local computer 42 and the mobile phone 32 of the intended call recipient 100.

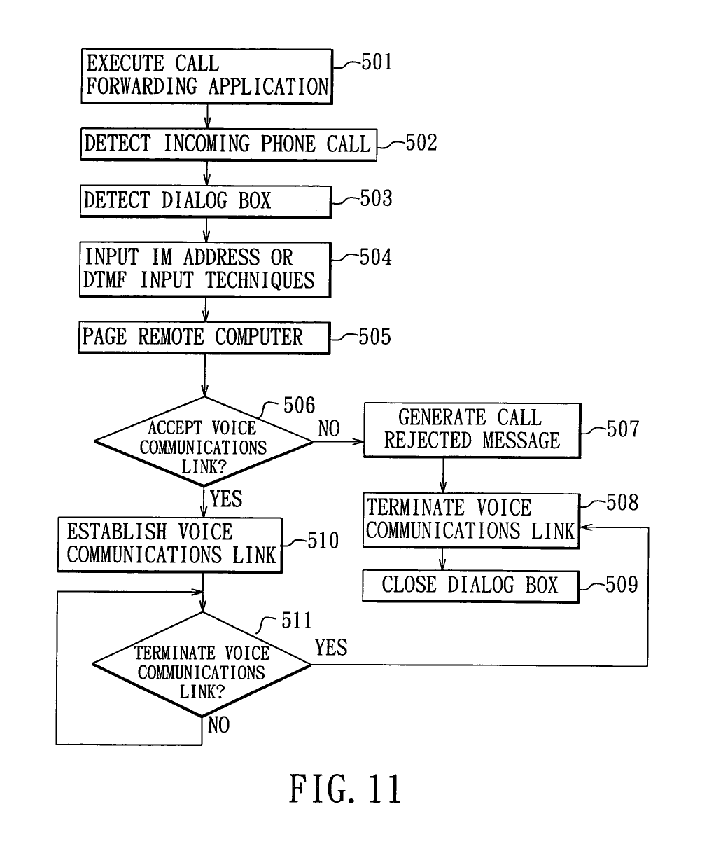

FIG. 8 illustrates steps associated with the “Direct Forward” option in greater detail. Initially, instep 101, the call forwarding application is executed to enable the intended call recipient 100 to specify a telephone number of his mobile phone 32. Then, the appearance of a dialog box in the instant messenger environment of the local computer 42 (i.e., due to paging by the remote computer 41 of the calling party 200) is detected through the call forwarding application in step 102. Thereafter, in step 103, the buddy preferences set in the buddy list 711 are inspected to verify whether the intended call recipient 100 has granted the calling party 200 the “Direct Forward” call privilege. If not, the flow goes to step 104, where a reject message is formed based on the result obtained in step 103. In step 105, the reject message is sent to the remote computer 41of the calling party 200. Then, instep 106, the dialog box of the local computer 42 is automatically closed. If it was determined in step 103 that the calling party 200 was granted the “Direct Forward” call privilege, the flow goes to step 107. In step 107, a previously established acknowledge message is sent to the remote computer 41 of the calling party 200. An example of the acknowledge message is: “I am not at home right now. If you wish to forward a call, please enter ‘0204’. If you do not wish to forward a call, please enter ‘8686’ or wait 60 seconds to exit automatically.” The keywords ‘0204’ and ‘8686’ are relied upon to determine whether or not the calling party 200 intends to proceed with establishment of a voice communications link via the “Direct Forward” option. In the affirmative (i.e., ‘0204’ was received from the remote computer 41), the flow goes to step 108, where the telephone number previously specified in the local computer 42 is dialed using the call forwarding device 1. Then, in step 109, it is determined if the intended call recipient 100 was able to accept the call. If not, the flow goes to step 110, where a call rejected message is sent to the remote computer 41 of the calling party 200, and then to step 106 so as to close the dialog box of the local computer 42.

If it was determined in step 109 that the intended call recipient 100 was able to accept the call, the flow goes to step 111. In step 111, the calling party 200 and the intended call recipient 100 are able to communicate with each other through a voice communications link that includes a data network link between the local and remote computers 42, 41, and a telephone network link between the local computer 42 and the intended call recipient 100 (that is, between the call forwarding device 1 and the mobile phone 32 of the intended call recipient 100). In step 112, it is determined via the call forwarding application whether a failure in communications has occurred due to an erroneous action performed by either the calling party 200 or the intended call recipient 100. In the affirmative, the flow goes to step 113 for failure handling, and then to step 114 so as to close the dialog box of the local computer 42, thereby terminating the voice communications link in order to permit future establishment of another voice communications link.

In step 115, it is further determined via the call forwarding application whether the voice communications link is to be terminated. Determination is made by detecting the presence of any one of the following conditions: (1) input of a call terminating command by the calling party 200 through the remote computer 41; (2) failure of the intended call recipient 100 to respond within a specified time period; and (3) closing of the instant messenger environment of the remote computer 41. In this embodiment, the call terminating command is ‘8686’, and the specified time period is 60 seconds. It should be noted herein that the call terminating command may be replaced by any other specific command, and the specified time period may also vary depending on actual requirements. When it is determined that the voice communications link is to be terminated, the voice communications link is terminated in step 116, and the flow goes to step 114 to close the dialog box of the local computer 42.

(B) “Remote Forward” Option

The setup for the “Remote Forward” option is the same as that shown in FIG. 7. However, unlike the “Direct Forward” option, the telephone number dialed by the call forwarding device 1 is not one that was previously configured by the intended call recipient 100, but is instead a telephone number specified by the calling party 200.

FIG. 9 illustrates steps associated with the “Remote Forward” option in greater detail. First, in step 201, the appearance of a dialog box in the instant messenger environment of the local computer 42 (i.e., due to paging by the remote computer 41 of the calling party 200) is detected through the call forwarding application. Thereafter, in step 202, the buddy preferences set in the buddy list 711 are inspected to verify whether the calling party 200 has been granted the “Remote Forward” call privilege. If not, the flow goes to step 203, where a reject message is formed based on the result obtained in step 202. In step 204, the reject message is sent to the remote computer 41 of the calling party 200. Then, in step 205, the dialog box of the local computer 42 is automatically closed.

If it was determined in step 202 that the calling party 200 was granted the “Remote Forward” call privilege, the flow goes to step 206. In step 206, an acknowledge message is sent to the remote computer 41 of the calling party 200 for prompting the latter to input the telephone number of an intended call recipient 100. In step 207, upon receipt from the remote computer 41 of the calling party 200, the intended telephone number is dialed using the call forwarding device 1. Then, in step 208, it is determined if the intended call recipient 100 was able to accept the call. If not, the flow goes to step 209, where a call rejected message is sent to the remote computer 41 of the calling party 200, and then to step 205 so as to close the dialog box of the local computer 42.

If it was determined in step 208 that the intended call recipient 100 was able to accept the call, the flow goes to step 210. In step 210, the calling party 200 and the intended call recipient 100 are able to communicate with each other through a voice communications link that includes a data network link between the local and remote computers 42, 41, and a telephone network link between the local computer 42 and the intended call recipient 100. In step 211, it is determined via the call forwarding application whether a failure in communications has occurred due to an erroneous action performed by either the calling party 200 or the intended call recipient 100. In the affirmative, the flow goes to step 212 for failure handling, and then to step 213 so as to close the dialog box of the local computer 42, thereby terminating the voice communications link in order to permit future establishment of another voice communications link.

In step 214, it is further determined via the call forwarding application whether the voice communications link is to be terminated. Determination is made in a manner similar to that described hereinabove in connection with the “Direct Forward” option. When it is determined that the voice communications link is to be terminated, the voice communications link is terminated in step 215, and the flow goes to step 213 to close the dialog box of the local computer 42.

(ii) The User is a Calling Party:

The following options are available when the user is the calling party: (C) Phone-to-PC Direct Forward; (D) Phone-to-PC Remote Forward; (E) Phone-to-Phone Direct Forward; and (F) Phone-to-Phone Remote Forward. These four options will be described in greater detail in the succeeding paragraphs.

(C) “Phone-to-PC Direct Forward” Option

This option will be illustrated using the same setup shown in FIG. 7. However, it is assumed herein that the user (hereinafter referred to as the calling party 100), who is a resident of the United States, is not at home, is in another state, and is carrying a mobile phone 32 with him. The calling party 100 wishes to contact a person (hereinafter referred to as the intended call recipient 200) living in Taiwan. Through a telephone network link made using the mobile phone 32 and established with a call forwarding device 1 that is connected to a local computer 42 operating in an instant messenger environment and installed in the user's home, the calling party 100 is able to page a remote computer 41 (that also operates in an instant messenger environment) of the intended call recipient 200 via a data network 5 to which the local and remote computers 42, 41 are connected. The “Phone-to-PC Direct Forward” option enables the calling party 100 to get in touch with the intended call recipient 200 through a voice communications link that includes the data network link between the remote and local computers 41, 42, and the telephone network link between the call forwarding device 1 of the local computer 42 and the mobile phone 32 (or any other telephone device) of the calling party 100.

FIG. 10 illustrates steps associated with the “Phone-to-PC Direct Forward” option in greater detail. First, in step 401, the call forwarding application is executed by the local computer 42, and in step 402, the calling party 100 is able to specify an instant messenger (IM) address of the intended call recipient 200. Then, instep 403, the presence of an incoming phone call placed by the calling party 100 and received by the local computer 42 through the call forwarding device 1 that is connected to the telephone network 2 is detected via the call forwarding application. In the affirmative, the flow goes to step 404, where the presence of a dialog box indicative of the instant messenger environment of the local computer 42 is detected through the call forwarding application. Then, in step 405, the instant messenger function of the local computer 42 is activated for paging the remote computer 41 of the intended call recipient 200 using the instant messenger address specified in step 402. Subsequently, in step 406, it is determined if the intended call recipient 200 is willing to accept establishment of a voice communications link. This is made possible by detecting an acknowledge message issued by the remote computer 41 and received by the local computer 42 through the data network 5. If the intended call recipient 200 is unwilling, the flow goes to step 407, where a call rejected message is generated, and then to step 408, where the voice communications link is terminated. Finally, the flow goes to step 409, where the dialog box of the local computer 42 is automatically closed.

If it was determined in step 406 that the intended call recipient 200 is willing, the flow goes to step 410. In step 410, the intended call recipient 200 and the calling party 100 are able to communicate with each other through a voice communications link that includes the data network link between the local and remote computers 42, 41, and the telephone network link between the local computer 42 and the calling party 100 (that is, between the call forwarding device 1 and the mobile phone 32 of the calling party 100). In step 411, it is further determined whether the voice communications link is to be terminated. In the affirmative, the flow goes to step 408 to terminate the voice communications link, and then to step 409 to close the dialog box of the local computer 42.

(D) “Phone-to-PC Remote Forward” Option

The setup for the “Phone-to-PC Remote Forward” option is the same as that shown in FIG. 7. However, unlike the “Phone-to-PC Direct Forward” option, there is no need to specify the instant messenger (IM) address of the intended call recipient 200 in the local computer

FIG. 11 illustrates steps associated with the “Phone-to-PC Remote Forward” option in greater detail. First, in step 501, the call forwarding application is executed by the local computer 42, and in step 502, the presence of an incoming phone call placed by the calling party 100 and received by the local computer 42 through the call forwarding device 1 that is connected to the telephone network 2 is detected via the call forwarding application. In the affirmative, the flow goes to step 503, where the presence of a dialog box indicative of the instant messenger environment of the local computer 42 is detected through the call forwarding application. Then, in step 504, the calling party 100 is permitted to input the instant messenger (IM) address of the remote computer 42 of the intended call recipient 200 via known voice or DTMF input techniques. Accordingly, one of DTMF decoding technology and voice-recognition technology can be employed to recognize the data inputted by the calling party 100. Thereafter, in step 505, the instant messenger function of the local computer 42 is activated for paging the remote computer 41 of the intended call recipient 200 using the instant messenger address specified by the calling party 100 in step 504. Subsequently, in step 506, it is determined if the intended call recipient 200 is willing to accept establishment of a voice communications link. This is made possible by detecting an acknowledge message issued by the remote computer 41 and received by the local computer 42 through the data network 5. If the intended call recipient 200 is unwilling, the flow goes to step 507, where a call rejected message is generated, and then to step 508, where the voice communications link is terminated. Finally, the flow goes to step 509, where the dialog box of the local computer 42 is automatically closed.

If it was determined in step 506 that the intended call recipient 200 is willing, the flow goes to step 510. In step 510, the intended call recipient 200 and the calling party 100 are able to communicate with each other through a voice communications link that includes the data network link between the local and remote computers 42, 41, and the telephone network link between the local computer 42 and the calling party 100 (that is, between the call forwarding device 1 and the mobile phone 32 of the calling party 100). In step 511, it is further determined whether the voice communications link is to be terminated. In the affirmative, the flow goes to step 508 to terminate the voice communications link, and then to step 509 to close the dialog box of the local computer 42.

(E) “Phone-to-Phone Direct Forward” Option

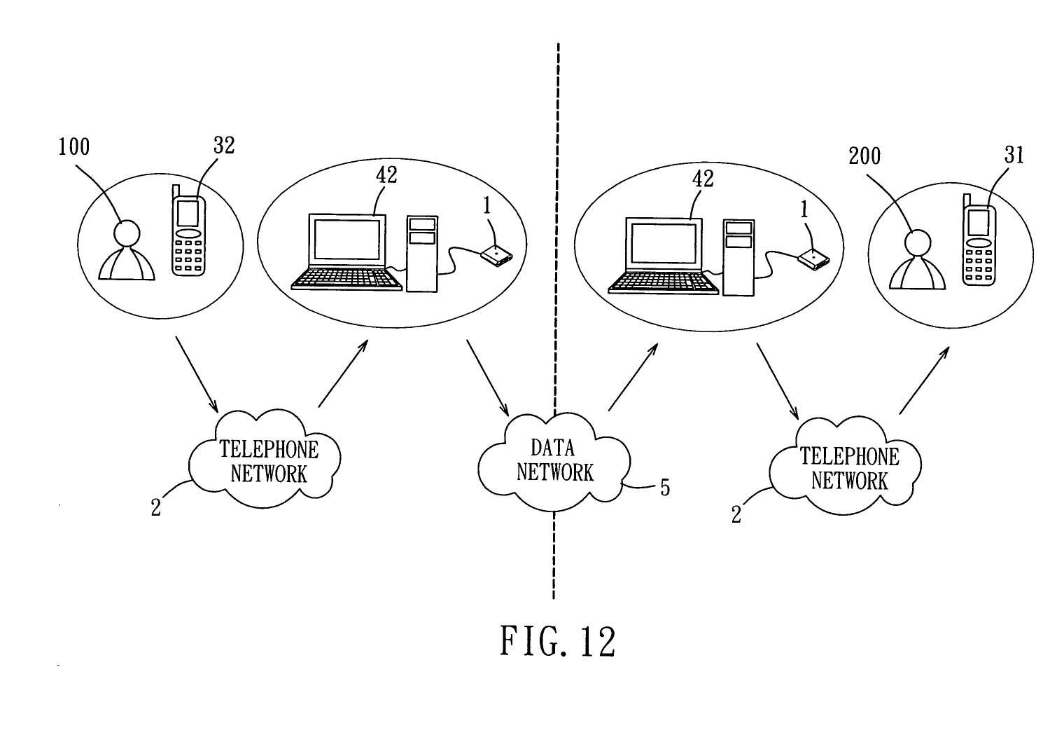

This option will be illustrated using the setup shown in FIG. 12. It is assumed herein that the user (hereinafter referred to as the calling party 100), who is a resident of the United States, is not at home, is in another state, and is carrying a mobile phone 32 with him. The calling party 100 wishes to contact a person (hereinafter referred to as the intended call recipient 200) living in Taiwan. However, the intended call recipient 200 is also not at home and is in another city in Taiwan. Through a first telephone network link made using the mobile phone 32 and established with a call forwarding device 1 that is connected to a local computer 42 operating in an instant messenger environment and installed in the user's home, the calling party 100 is able to page a remote computer 41 (that also operates in an instant messenger environment) of the intended call recipient 200 via a data network 5 to which the local and remote computers 42, 41 are connected. Then, through a second telephone network link established between another call forwarding device 1 that is connected to the remote computer 41 and a mobile phone 31 of the intended call recipient 200, the “Phone-to-Phone Direct Forward” option enables the calling party 100 to get in touch with the intended call recipient 200 through a voice communications link that includes the first telephone network link between the calling party 100 and the local computer 42 (i.e., between the mobile phone 32 of the calling party 100 and the call forwarding device 1 that is connected to the local computer 42), the data network link between the remote and local computers 41, 42, and the second telephone network link between the intended call recipient 200 and the remote computer 41 (i.e., between the call forwarding device 1 of the remote computer 41 and the mobile phone 31 of the intended call recipient 200).

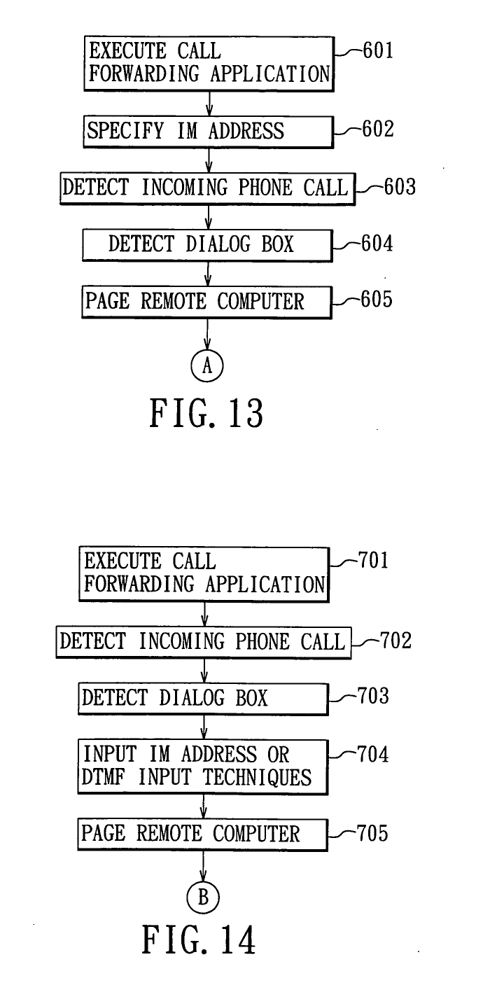

FIG. 13 illustrates steps associated with the “Phone-to-Phone Direct Forward” option. The steps 601 to 605 of FIG. 13 correspond to the steps 401 to 405 of FIG. 10 and are performed by the local computer 42. As for the steps performed by the remote computer 41, they are the same as steps 103 to 116 of FIG. 8. In this manner, the voice communications link that includes two telephone network links and a data network link can be made between the calling party 100 and the intended call recipient 200.

(F) “Phone-to-Phone Remote Forward” Option

The setup for the “Phone-to-Phone Remote Forward” option is the same as that shown in FIG. 12. However, unlike the “Phone-to-Phone Direct Forward” option, there is no need to specify the instant messenger (IM) address of the intended call recipient 200 in the local computer 42.

FIG. 14 illustrates steps associated with the “Phone-to-Phone Remote Forward” option. The steps 701 to 705 of FIG. 14 correspond to the steps 501 to 505 of FIG. 11 and are performed by the local computer 42. As for the steps performed by the remote computer 41, they are the same as steps 202 to 215 of FIG. 9. In this manner, the voice communications link that includes two telephone network links and a data network link can be made between the calling party 100 and the intended call recipient 200.

In the aforesaid “Phone-to-PC Direct Forward” and “Phone-to-PC Remote Forward” options, overseas phone costs can be saved, and only the user 100 incurs phone expense. In the aforesaid “Phone-to-Phone Direct Forward” and “Phone-to-Phone Remote Forward” options, overseas phone costs are also saved, but both the user 100 and the person 200 incur phone expense.

In sum, the method for making a voice communications link according to this invention offers the following advantages:

1. When the call forwarding device and the associated call forwarding application are installed on an electronic device of the user, and a telephone number was specified beforehand by the user, the user will be able to receive forwarded calls when he or she is not at home, and hence will not miss important messages.

2. The cost of making long distance calls can be saved.

3. Through the selective grant of call privilege to buddies in a buddy list, undesired forwarded calls can be screened, and the privacy of the user is thus ensured.

4. Unnecessary communication expenses can be saved by terminating the voice communications link upon occurrence of any one of predetermined conditions.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A method for making a voice communications link and to be implemented using local and remote computers, each of which operates in an instant messenger environment and is connected to a data network, the local computer being equipped with a call forwarding device for connecting to a telephone network, said method comprising:
a) in response to an incoming phone call placed by a calling party and received by the local computer through the call forwarding device that is connected to the telephone network, enabling activation of the instant messenger function of the local computer for paging the remote computer; and
b) in response to an acknowledge message issued by the remote computer to accept establishment of the voice communications link and received by the local computer through the data network, activating the instant messenger function of the local and remote computers for establishing the voice communications link that includes a telephone network link between the calling party and the local computer, and a data network link between the local and remote computers.

2. The method of claim 1, wherein, in step a), paging of the remote computer is conducted using an instant messenger address associated with the remote computer and specified beforehand in the local computer.

3. The method of claim 1, wherein, in step a), paging of the remote computer by the local computer is made possible through input of an instant messenger address associated with the remote computer by the calling party, one of DTMF decoding technology and voice-recognition technology being employed to recognize the instant messenger address.

4. A method for making a voice communications link and to be implemented using local and remote computers, each of which operates in an instant messenger environment, is connected to a data network, and is equipped with a respective call forwarding device for connecting to a telephone network, said method comprising:
a) in response to an incoming phone call placed by a calling party and received by the local computer through the call forwarding device that is connected to the telephone network, enabling activation of the instant messenger function of the local computer for paging the remote computer;
b) activating the instant messenger function of the remote computer for enabling the remote computer to issue an acknowledge message to the local computer when the remote computer is paged through the data network;
c) enabling the remote computer to activate the call forwarding device thereof for placing an outgoing phone call to an intended call recipient through the telephone network; and
d) activating the instant messenger function of the local and remote computers for establishing the voice communications link that includes a first telephone network link between the calling party and the local computer, a data network link between the local and remote computers, and a second telephone network link between the remote computer and the intended call recipient.

5. The method of claim 4, wherein, in step a), paging of the remote computer is conducted using an instant messenger address associated with the remote computer and specified beforehand in the local computer.

6. The method of claim 4, wherein, in step a), paging of the remote computer by the local computer is made possible through input of an instant messenger address associated with the remote computer by the calling party, one of DTMF decoding technology and voice-recognition technology being employed to recognize the instant messenger address.

7. The method of claim 4, wherein, in step c), the remote computer is enabled to activate the call forwarding device thereof upon receipt of a call forwarding command issued by the local computer through the data network.

8. The method of claim 4, wherein, instep c), the outgoing phone call is placed using a telephone number specified beforehand in the remote computer.

9. The method of claim 4, wherein, in step c), the outgoing phone call is placed using a telephone number specified by the calling party and received by the remote computer through the first telephone network link and the data network link.

10. A method for making a voice communications link and to be implemented using a local computer that operates in an instant messenger environment, that is connected to a data network, and that is equipped with a call forwarding device for connecting to a telephone network, said method comprising:
a) in response to paging of the local computer through the data network by a remote computer that also operates in the instant messenger environment, enabling activation of the call forwarding device for placing an outgoing phone call to an intended call recipient through the telephone network using a specified telephone number, thereby permitting establishment of the voice communications link between the user of the remote computer and the intended call recipient.

11. The method of claim 10, wherein, in step a), the specified telephone number was stored beforehand in the local computer.

12. The method of claim 10, wherein, in step a), the specified telephone number is received by the local computer from the remote computer.

13. The method of claim 10, wherein step a) includes verifying call privilege granted to the user of the remote computer before enabling activation of the call forwarding device.

14. The method of claim 13, wherein verification of the call privilege is conducted by inspecting buddy preferences set in a buddy list that was established beforehand in the local computer.

15. The method of claim 10, further comprising:
b) terminating the voice communications link when a predetermined condition is detected, the predetermined condition being one of
input of a call terminating command by the user of the remote computer,
failure of the intended call recipient to accept the outgoing phone call within a specified time period, and
closing of the instant messenger environment of the remote computer.
